(19) United States
(12) Patent Application Publication
(10) Pub. No.: US 2019/0110340 A1
(43) Pub. Date: Apr. 11, 2019

(54) COOKING APPLIANCE HAVING A PLANAR ANTENNA AND METHOD FOR OPERATING A COOKING APPLIANCE

(71) Applicant: BSH Hausgeräte GmbH, Munich (DE)

(72) Inventors: Hans-Jürgen Bauer, Traunstein (DE); Wolfgang Beifuss, Chieming (DE); Harald Pfersch, Freilassing (DE); Manfred Steinbacher, Inzell (DE); Martin Thalheimer, Unterwössen (DE)

(21) Appl. No.: 16/088,837

(22) PCT Filed: Mar. 10, 2017
(86) PCT No.: PCT/EP2017/055707

§ 371 Date: Sep. 27, 2018

(30) Foreign Application Priority Data
Apr. 15, 2016 (DE) 10 2016 206 342.1

(51) Int. Cl. H05B 6/64; A23L 5/10

(52) U.S. Cl. CPC H05B 6/6467; A23V 2002/00; A23L 5/15; H05B 6/6479

(57) ABSTRACT

A cooking appliance includes a cooking chamber for cooking a product to be cooked. An air-guiding plate is arranged in the cooking chamber and coupled by a coupling device to a transmitter/receiver unit which transmits and/or receives a high frequency signal. The air-guiding plate is configured as a planar antenna for transmitting the high frequency signal between the coupling device and a sensor that can be arranged in the cooking chamber.

The present invention relates to a cooking appliance having a planar antenna and a method for operating a cooking appliance comprising the planar antenna as well as a sensor arranged in a cooking chamber of the cooking appliance.

Cooking appliances are designed for cooking a product to be cooked, such as food or meals. In particular, the temperature of the product to be cooked is important for a cooking process. Therefore, it is desirable that the temperature of the product to be cooked is able to be measured and/or monitored. Both the temperature and a time-temperature curve may have a significant influence on the quality of the product to be cooked. In addition to the temperature, further parameters may also be relevant to a cooking process.

For measuring the temperature of the product to be cooked, generally sensors with temperature probes are used, said temperature probes being introduced from outside into the product to be cooked. These temperature probes are configured, for example, as a skewer thermometer which is inserted into the product to be cooked. In this case, it is advantageous if the sensor is independent of the cooking appliance, i.e. in particular that it does not require a cable connection to the cooking appliance. Only then is it possible to position the sensor in the product to be cooked in a user-friendly manner outside the cooking chamber and/or to move the product to be cooked together with the sensor positioned therein during the cooking process, for example by means of a rotating spit.

A feature here is to emit the measured temperature to a user and/or a control device of the cooking appliance by means of a wireless communication connection with the sensor.

Such a device is disclosed in the European patent application EP 2663160 A1. The device disclosed therein comprises a treatment chamber and a coupling apparatus. The coupling apparatus serves for transmitting electromagnetic waves into the treatment chamber. In this case, the coupling apparatus is arranged in a secondary chamber and the secondary chamber is separated via a partition wall from the treatment chamber. The coupling apparatus is configured to produce an electromagnetic field between a first metal wall and an adjacent second metal wall. An opening is also provided, electromagnetic radiation being emitted out of said opening into the treatment chamber.

In view of this background to the invention, an object of the present invention is to provide an improved device in order to permit wireless communication with a sensor arranged in the cooking chamber of a cooking appliance.

Accordingly, a cooking appliance having a cooking chamber for cooking a product to be cooked is proposed. The cooking appliance has at least one air-guiding plate arranged in the cooking chamber, a transmitter/receiver unit for transmitting and/or receiving a high-frequency signal and a coupling device for coupling the transmitter/receiver unit and the air-guiding plate. In this case, the air-guiding plate is in the form of a planar antenna for transmitting the high-frequency signal between the coupling device and a sensor that can be arranged in the cooking chamber.

This advantageously enables a signal provided by a mobile sensor, such as for example a skewer thermometer, to be able to be transmitted to further appliances, for example a display apparatus and/or a control device. In particular, this may be carried out in a visually unobtrusive manner by means of the proposed arrangement of the transmitter/receiver unit, the coupling device and the air-guiding plate configured as a planar antenna, since all components may be arranged behind the air-guiding plate and/or outside the cooking chamber or even at any point outside the cooking chamber. It is also advantageous that a separate antenna is not required, whereby the complexity of the cooking appliance is not further increased. As a result, the manufacture is simplified and costs are saved. Moreover, by means of the proposed arrangement existing cooking appliances may also be retrofitted with this functionality.

A cooking chamber is a volume enclosed by side walls, wherein the side walls are also designed, in particular, to withstand high or very high temperatures. High and/or very high temperatures are, for example, above 400° C. or even above 600° C. Such a cooking chamber is thus suitable for self-cleaning processes such as pyrolysis. Moreover, the cooking chamber is able to be loaded via a door which may be opened and closed and which is incorporated in one of the side walls.

An air-guiding plate is formed as a planar body from a heat-resistant material which is designed to conduct an airflow inside the cooking chamber in the desired manner. Heat-resistant means that the material is able to withstand very high temperatures. For the air guidance, the air-guiding plate may comprise openings such as holes and/or slots through which air may flow. Moreover, the air-guiding plate may deviate from a planar shape at least in places and, for example, comprise curved portions. In particular, the air-guiding plate may be angled at the edges. The air-guiding plate is also fixed by means of at least one mounting to at least one side wall of the cooking chamber, whereby the position of the air-guiding plate is fixed in the cooking chamber. A mounting may, for example, encompass a screw, a nail, a nipple, a retaining clip and/or further objects and combinations thereof which are suitable for fixing the air-guiding plate relative to the cooking chamber.

The air-guiding plate advantageously extends over a larger region of a side wall and is arranged parallel thereto or at least at only a small angle thereto. A larger region means, for example, that the surface of the side wall covered by the air-guiding plate is at least 25%, up to 50%, or even up to 100% of the surface of the side wall. A small angle within the meaning of the arrangement means, for example, less than 10°, less than 20° or even less than 45°.

A transmitter/receiver unit is an analog and/or digital circuit which is designed to generate and to transmit and/or to receive and to filter an analog and/or digital signal. A transmitter unit is also denoted as a transponder. A receiver unit is also denoted as a receiver. A transmitter/receiver unit is also denoted as a transceiver.

A high-frequency signal is, in particular, an electrical alternating voltage which has a high alternating frequency. Preferably, the frequency of the high-frequency signal is in an ISM band, particularly preferably between 433.05-434.79 MHz.

A coupling device is a device which is designed to connect an input and/or an output of the transmitter/receiver unit to a further component, for example the air-guiding plate, such that the transmission of an electrical signal, in particular of the high-frequency signal, is possible. This is, for example, an electrical conductor such as a cable, in particular a coaxial cable.

A planar antenna is a planar component which is suitable for emitting and/or receiving electromagnetic radiation. A planar antenna may also be denoted as a surface emitter. For example, a patch antenna is an embodiment of a planar antenna. In particular, the air-guiding plate configured as a planar antenna is suitable for receiving and/or emitting the high-frequency signal.

Advantageously, the air-guiding plate configured as a planar antenna is arranged, for example, vertically on the side wall opposite the door of the cooking chamber. This has the advantage that the high-frequency signal is able to be received by the planar antenna even if, for example, racks for food and/or food which absorb the high-frequency signal are located in the cooking chamber.

A sensor, in particular a temperature sensor, comprises a measuring unit, in particular a temperature probe, and an electrical circuit for activating and/or reading the measuring unit. In this case “reading” means that a measured value is determined by the electrical circuit by means of the measuring unit. Moreover, the sensor comprises input means and output means in order to be able to create a wireless communication connection with a further unit. This further unit is, in particular, the transmitter/receiver unit. The sensor may also be configured to detect further relevant cooking parameters, such as for example air humidity, oxygen concentration and/or an electrical field strength. Such a sensor has the advantage that a cooking process may be monitored and also an end point of the cooking process may be automatically determined. The end point is reached, for example, when the core temperature of the food to be cooked reaches and/or exceeds a predetermined temperature.

Moreover, the sensor may also comprise an energy source for operating the sensor. This energy source may, for example, be a battery. Alternatively, the sensor may also draw the energy required for its operation from thermal energy present in the cooking chamber and/or from an electromagnetic field. This design is advantageous since it prevents a user having to monitor the energy supply of the sensor. Moreover, many energy sources such as batteries are not designed for operation at high or very high temperatures and/or they contain toxic substances which may be transferred into food in the case of a fault, which is prevented hereby.

According to one embodiment of the cooking appliance, the coupling device comprises a spiral-shaped electrical line for capacitive coupling with the air-guiding plate for transmitting the high-frequency signal.

Advantageously, an efficient signal coupling is ensured thereby, wherein at the same time large low-frequency currents are suppressed. “Spiral-shaped” is to be understood to mean that the electrical line has a curved shape. In this case, it is sufficient if the electrical line has a curvature at at least one point. It is particularly advantageous if the electrical line covers a larger surface of the air-guiding plate. A larger surface means that, for example, a projection of the spiral-shaped electrical line in the perpendicular direction toward the air-guiding plate covers a larger surface than a projection of an electrical line without a spiral shape. In particular, an end of the electrical line may have such a spiral shape.

An electrical line is an electrically conductive material which is capable of transmitting the high-frequency signal. This electrical line is, in particular, a coaxial cable. A coaxial cable comprises at least one core and a shield.

According to a further embodiment of the cooking appliance, the spiral-shaped electrical line is arranged to the rear, to the front, above, below and/or to the side relative to the air-guiding plate.

This has the advantage that the spiral-shaped electrical line may be arranged relative to the air-guiding plate such that further structural conditions may be fulfilled. This relates, in particular, to the spatial arrangement of further components. Additionally, an efficient coupling of the air-guiding plate with the transmitter/receiver unit may be ensured thereby.

Moreover, it is also conceivable that the coupling device comprises two or more spiral-shaped electrical lines which may then be arranged relative to the air-guiding plate such that an efficient coupling of the air-guiding plate with the transmitter/receiver unit is achieved. On the one hand, this may improve the efficiency of a signal transmission and, on the other hand, such a dual design may also cause a redundancy of the coupling device which results in a fail-safety of the system.

According to a further embodiment of the cooking appliance, a position of the spiral-shaped electrical line relative to the air-guiding plate is dependent on the position of the at least one mounting of the air-guiding plate and/or is dependent on a spacing of an edge of the air-guiding plate from the side wall such that an impedance of the air-guiding plate is adapted to an impedance of the coupling device.

Such an adaptation of the impedance is advantageous in order to ensure an efficient coupling of the high-frequency signal and thus to achieve a transmission and/or reception of the high-frequency signal.

According to a further embodiment of the cooking appliance, the spiral-shaped electrical line is configured as a component which may be removed and/or added.

“May be removed” is understood here to mean that the component may be transferred from a state installed in the cooking appliance to a state released from the cooking appliance. “May be added” is understood here to mean that the component may be transferred from the state released from the cooking appliance into the state installed in the cooking appliance. This has the advantage that a defective spiral-shaped electrical line may be replaced by an intact spiral-shaped electrical line without the cooking appliance having to be dismantled as a whole. Moreover, the component may also be retrofitted.

According to a further embodiment of the cooking appliance, the air-guiding plate has an opening designed for passing the component through.

This has the advantage that the spiral-shaped electrical line may be removed and/or added without the air-guiding plate itself having to be dismantled. “Passing through” is understood here to mean that the component is moved through the opening from a first side to a second side of the air-guiding plate. An opening designed therefor may comprise, for example, a hole and/or a slot.

According to a further embodiment of the cooking appliance, the spiral-shaped electrical line is produced from a heat-resistant spring material.

This has the advantage, in particular, that a spacing may be kept constant between the air-guiding plate and the spiral-shaped electrical line without the spiral-shaped electrical line having to be fixedly connected to the air-guiding plate. Due to the spring properties of the spring material a certain tolerance in the relative positioning of the air-guiding plate and the spiral-shaped electrical line is provided thereby, in particular relative to a spacing of the air-guiding plate from the coupling device.

According to a further embodiment of the cooking appliance, the air-guiding plate is produced from a steel plate which is coated with an electrically insulating layer.

This ensures, in particular, that a direct current between the transmitter/receiver unit, which is coupled to the air-guiding plate by means of the coupling device, and the air-guiding plate is suppressed. Due to the capacitive coupling, however, a transmission of the high-frequency signal is possible.

According to a further embodiment of the cooking appliance, the air-guiding plate is enameled.

According to a further embodiment of the cooking appliance, an earth for the planar antenna is galvanically coupled by means of an earth line to at least one side wall of the cooking chamber.

The earth line is provided, in particular, by the shield of a coaxial cable. The galvanic coupling is, for example, achieved by direct screw connection of the shield to the side wall. Alternatively, the earth line may also be welded or soldered to the side wall, or otherwise connected to the side wall. It is advantageously ensured thereby that the reference earth of the high-frequency signal has a potential which coincides with a potential of the side wall. Preferably, all of the side walls of the cooking chamber are in conductive contact with one another so that all of the side walls have the same potential.

According to a further embodiment of the cooking appliance, the planar antenna is configured for transmitting the high-frequency signal in an ISM band.

The ISM band comprises frequencies in the region of 434 MHz, in particular 433.05-434.79 MHz. A use of the arrangement based on a general allocation is herewith legally permitted.

According to a further embodiment of the cooking appliance, the transmitter/receiver unit is designed for transmitting a first high-frequency signal by means of the planar antenna to the sensor at predeterminable times and/or depending on the presence of a triggering signal. Alternatively or additionally, the planar antenna is designed for receiving a second high-frequency signal emitted by the sensor, by means of the planar antenna at predeterminable times and/or according to the presence of a triggering signal.

It may be advantageously ensured thereby that a sensor signal is currently present. Predeterminable times may be defined in one minute intervals, in five minute intervals or even after ten minutes, for example after the start of cooking. Further predeterminable times may also be determined as desired by means of analytical functions, recursive sequences, value tables and/or combinations thereof. Thus the transmitter/receiver unit is also designed, for example, to determine the predeterminable times. The times may be individual times or periodically or otherwise regularly or irregularly repeating times. The triggering signal comprises, in particular, a signal generated by a user. The triggering signal, however, may also be provided by reaching a specific temperature in the cooking chamber. In particular, the triggering signal may also be generated by the sensor itself.

According to a further embodiment, the cooking appliance comprises a heating coil, a steam generator, a microwave generator and/or a fan.

According to a further embodiment, the cooking appliance is configured as an oven, a microwave oven and/or a steam cooker.

Moreover, a method is proposed for operating a cooking appliance, having a cooking chamber for cooking a product to be cooked and an air-guiding plate arranged in the cooking chamber and configured as a planar antenna, a transmitter/receiver unit for transmitting and/or receiving a high-frequency signal and a coupling device for coupling the transmitter/receiver unit and the air-guiding plate, and a sensor arranged in the cooking chamber, comprising: the transmission of the high-frequency signal between the transmitter/receiver unit and the sensor by means of the planar antenna.

The embodiments and features described for the proposed cooking appliance accordingly apply to the proposed method.

Further possible implementations of the invention also comprise not explicitly cited combinations of features or embodiments described above or below relative to the exemplary embodiments. In this case, the person skilled in the art will also add individual features as improvements or additions to the respective basic form of the invention.

Further advantageous embodiments and aspects of the invention form the subject-matter of the subclaims and the exemplary embodiments of the invention described hereinafter. Moreover, the invention is described in more detail by means of preferred embodiments with reference to the accompanying figures.

FIG. 1 shows a schematic block diagram of an embodiment of a cooking appliance;

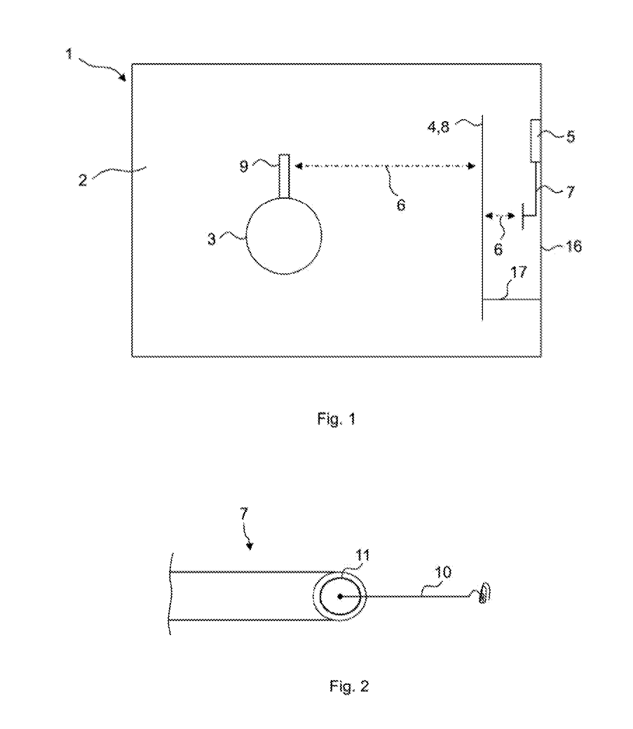

FIG. 2 shows a schematic block diagram of an embodiment of a coupling device;

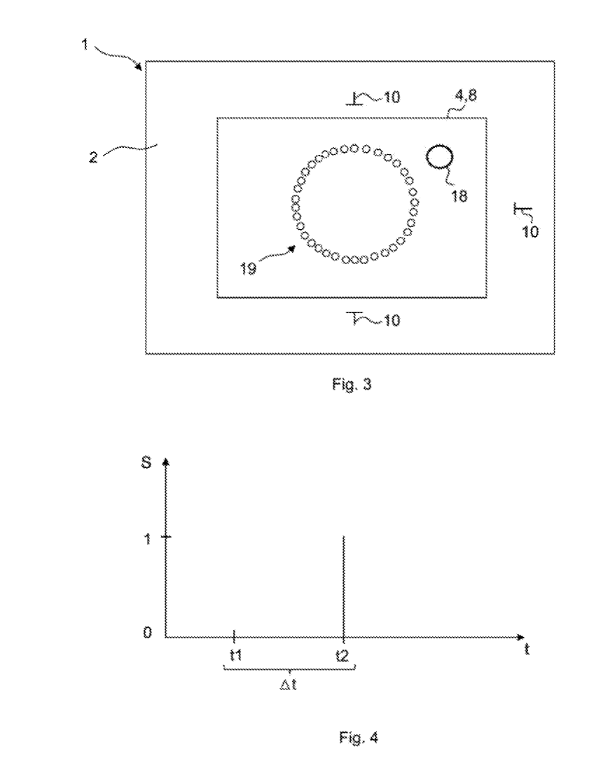

FIG. 3 shows a schematic block diagram of a further embodiment of a cooking appliance;

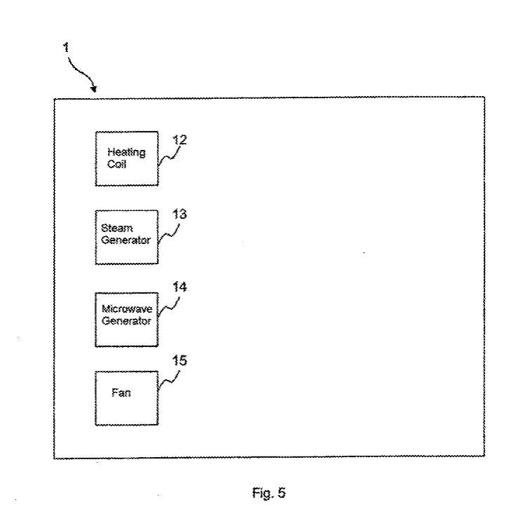

FIG. 4 shows a time diagram as an example of the presence of a triggering signal;

FIG. 5 shows a schematic block diagram of a further embodiment of a cooking appliance;

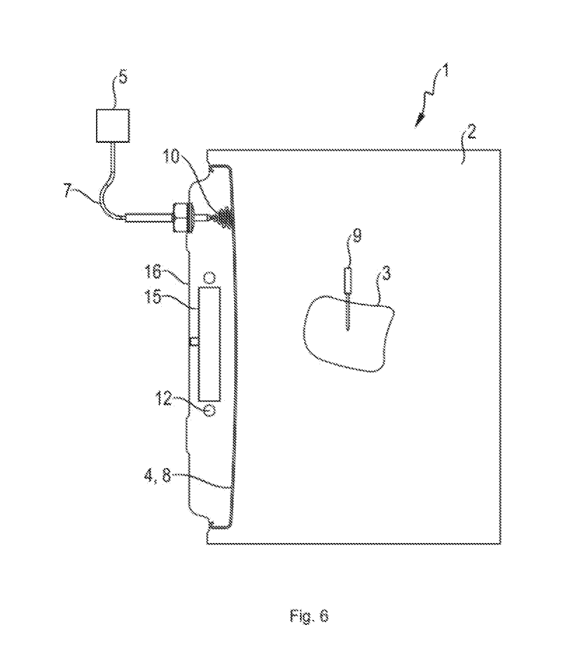

FIG. 6 shows a schematic block diagram of a further embodiment of a cooking appliance;

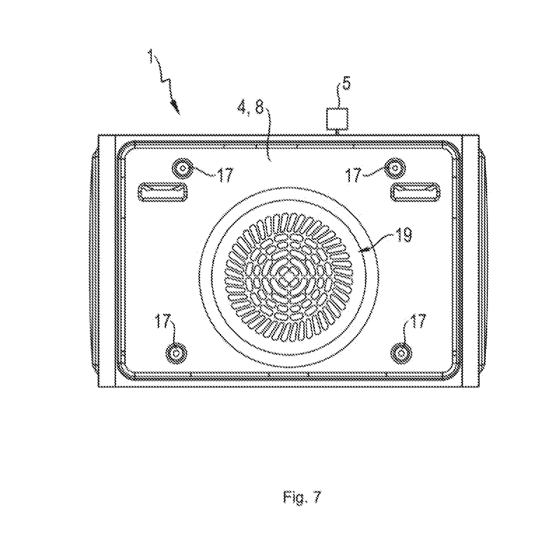

FIG. 7 shows a schematic block diagram of a front view of a further embodiment of a cooking appliance; and

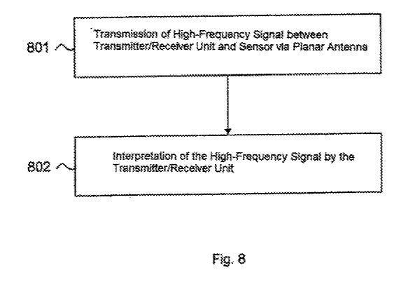

FIG. 8 shows a flow diagram of a method for operating a cooking appliance.

Elements which are the same or functionally the same are provided with the same reference characters in the figures, provided nothing further is specified.

FIG. 1 shows a schematic block diagram of an embodiment of a cooking appliance 1. The cooking appliance 1 shown comprises a cooking chamber 2 in which a product 3 to be cooked is located. A sensor 9 is fixed in the product 3 to be cooked. Moreover, the cooking appliance 1 comprises a transmitter/receiver unit 5, a coupling device 7 and an air-guiding plate 4, which is fixed by means of a mounting 17 to a side wall 16 of the cooking chamber 2.

In the exemplary embodiment of FIG. 1, for example, a high-frequency signal 6 is generated in the transmitter/receiver unit 5. The high-frequency signal 6 is transmitted by means of the coupling device 7 by the transmitter/receiver unit 5 to the air-guiding plate 4. The coupling device 7 is capacitively coupled with the air-guiding plate 4, which in the view of FIG. 1 is shown by a gap between the coupling device 7 and the air-guiding plate 4. The high-frequency signal 6 is shown by means of a double arrow connected by a dashed line. The air-guiding plate 4 is designed in the exemplary embodiment as a planar antenna 8. The planar antenna 8 is designed to emit the high-frequency signal 6 into the cooking chamber 2. The high-frequency signal 6 may, therefore, be transmitted to the sensor 9 fixed in the product 3 to be cooked. For example, the sensor 9 receives the high-frequency signal 6 and in turn generates a further high-frequency signal 6 which is received by the planar antenna 8 and by means of the capacitive coupling may be transmitted to the coupling device 7 and further to the transmitter/receiver unit 5. The transmitter/receiver unit 5 is designed to interpret the further high-frequency signal 6 received. The sensor 9 is, for example, a skewer thermometer, wherein the high-frequency signal 6 is then designed to transmit temperature information. The high-frequency signal 6 is located, in particular, in a frequency range of 433.05-434.79 MHz.

Deviating from the view of FIG. 1 the transmitter/receiver unit 5 may also be arranged outside the cooking chamber 2 (see for example FIG. 6). Then the coupling device 7 may then be passed through an opening in the side wall 16 provided therefor.

FIG. 2 shows a schematic block diagram of an embodiment of a coupling device 7 which is configured as a spiral-shaped electrical line 10. In the example of FIG. 2, the coupling device 7 is shown as a coaxial cable 7. The coaxial cable 7 comprises, in particular, a core 10 and a shield 11. Both the core 10 and the shield 11 are produced from electrically conductive materials.

In the example of FIG. 2 the core 10 of the coaxial cable 7 is configured as the spiral-shaped electrical line 10. To this end, an end of the spiral-shaped electrical line 10 is curved in a spiral shape. This arrangement has the advantage that the high-frequency signal 6 may be capacitively transmitted in a particularly efficient manner, since a large surface of the air-guiding plate 4 is covered, whereby the interaction between the electrical line 10 and the air-guiding plate 4 is increased. The shield 11 is preferably galvanically coupled (not shown) to an earth, particularly preferably to the side wall 16 of the cooking chamber 2. Such a galvanic coupling may be achieved, for example, by means of a direct screw connection of the shield 11 to the side wall 16.

A suitable dielectric material is preferably located between the core 10 and the shield 11 in order to avoid a short circuit. Moreover, the shield 11 is preferably enclosed by an insulating layer in order to avoid faulty contacts.

FIG. 3 shows a schematic block diagram of a further embodiment of a cooking appliance 1 comprising a cooking chamber 2, an air-guiding plate 4 and a plurality of spiral-shaped electrical lines 10. The plurality of spiral-shaped electrical lines 10 forms as a whole the coupling device 7 (not shown). The air-guiding plate 4 of FIG. 3 configured as a planar antenna 8 also comprises an opening 18, which is designed for passing a component through, and a plurality of air openings 19. In the example of FIG. 3 the plurality of air openings 19 is arranged in a circle.

By the use of a plurality of spiral-shaped electrical lines 10 an optimized transmission of the high-frequency signal 6 to the air-guiding plate 4 may be achieved. In this case, the arrangement of the spiral-shaped electrical lines 10 may be selected as desired. In particular, the arrangement of the spiral-shaped electrical lines 10 may be selected such that further structural conditions of the cooking appliance 1 may be fulfilled. In the example of FIG. 3, in each case a spiral-shaped electrical line 10 is located below, above and to the right of the air-guiding plate 4. However, it is also conceivable that a plurality of the spiral-shaped electrical lines 10 may be arranged above, below, to the front, to the rear, and/or to the side adjacent to the air-guiding plate 4. Moreover, it is conceivable that individual spiral-shaped electrical lines 10 differ from one another. Such a difference could, for example, be in the configuration of the spiral shape.

The opening 18 of the air-guiding plate 4 of FIG. 3 is suitable, in particular, for a spiral-shaped electrical line 10 designed as a separate component to be able to be passed through said opening. Thus a spiral-shaped electrical line 10 mounted to the rear of the air-guiding plate 4 in a receiver (not shown) provided therefor, is accessible from the front through the air-guiding plate 4 and may be removed from the cooking appliance 1 or alternatively added thereto.

Moreover, the air openings 19 are suitable, in particular, for deflecting an airflow in the cooking chamber 2. Moreover, the air openings 19 may be suitable for influencing the physical properties of the air-guiding plate 4 which is configured as a planar antenna 8, such that the transmission properties of the planar antenna 8 are optimized.

FIG. 4 shows a time diagram as an example of the presence of a triggering signal. FIG. 4 shows a diagram with a time axis t and a signal axis S. The signal axis S in this case is shown as a binary system with the values 0 and 1. In the view of FIG. 4, for example, a measurement is started at a time t1. The measurement is intended to take place such that after a time period Δt=t2−t1 has passed the sensor 9 is read. After the time period Δt has passed, at the time t2, therefore the triggering signal is present. This is shown in FIG. 4 as a signal level 1 on the signal axis S. The triggering signal causes the transmitter/receiver device 5 to generate the high-frequency signal 6 in order to read the sensor 9.

As an alternative to this view, many further sequences of triggering signals are conceivable, for example triggering signals occurring periodically or triggering signals triggered by a further event, for example the actuation by a user of a control element provided therefor. With a periodic sequence of triggering signals a time period Δt between two successive triggering signals preferably has a duration in the range of seconds, i.e. 0.5 s, 1 s or even 10 s.

FIG. 5 shows a schematic block diagram of a further embodiment of a cooking appliance 1. In the example of FIG. 5 the cooking appliance 1 comprises, in addition to the devices shown in FIGS. 1, 3, 6 and/or 7, a heating coil 12, a steam generator 13, a microwave generator 14 and a fan 15.

FIG. 6 shows a schematic block diagram of a further embodiment of a cooking appliance 1. The cooking appliance 1 is shown in a side view. The cooking appliance 1 comprises a cooking chamber 2 with a product 3 to be cooked located therein. A sensor 9 is fixed in the product 3 to be cooked. Moreover, the cooking appliance 1 comprises a transmitter/receiver unit 5, a coupling device 7 with a spiral-shaped electrical line 10, and an air-guiding plate 4 which is configured as a planar antenna 8 which is arranged parallel to the side wall 16. Moreover, the cooking appliance 1 comprises a heating coil 12 and a fan 15. In particular, in the exemplary embodiment of FIG. 6 the transmitter/receiver unit 5 is arranged outside the cooking chamber 2. The coupling device 7 for coupling the air-guiding plate 4 to the transmitter/receiver unit 5 is passed through an opening in the side wall 16 designed therefor.

FIG. 7 shows a schematic block diagram of a front view of a further embodiment of a cooking appliance 1. In the example, the transmitter/receiver unit 5 is arranged outside the cooking chamber 2. The further functional elements, such as the coupling device 7 with the electrical line 10, are covered by the air-guiding plate 4 and, therefore, not shown in FIG. 7. The air-guiding plate 4, which is configured as a planar antenna 8, in the example has a plurality of air openings 19. Moreover, four mountings 17 are shown, the air-guiding plate 4 being fixed thereby to a side wall 16.

FIG. 8 shows a flow diagram of a method for operating the cooking appliance 1, in particular according to one of the embodiments of FIGS. 1, 3, or 5-7. The cooking appliance 1 comprises a cooking chamber 2 for cooking a product 3 to be cooked, an air-guiding plate 4 arranged in the cooking chamber 2 and configured as a planar antenna 8, a transmitter/receiver unit 5 for transmitting and/or receiving a high-frequency signal 6 and a coupling device 7 for coupling the transmitter/receiver unit 5 and the air-guiding plate 4, as well as a sensor 9 arranged in the cooking chamber 2.

In step 801 the high-frequency signal 6 is transmitted between the transmitter/receiver unit 5 and the sensor 9 by means of the planar antenna 8.

In step 802 the transmitted high-frequency signal 6 is interpreted by the transmitter/receiver unit 5.

Step 802 in this case is optional since the transmitter/receiver unit 5 may conduct the received high-frequency signal 6 further, for example also to a control device of the cooking appliance 1, which then undertakes the interpretation of the high-frequency signal 6.

Although the present invention has been described with reference to exemplary embodiments it may be modified in many different ways.

### REFERENCE CHARACTERS USED

1 Cooking appliance
2 Cooking chamber
3 Product to be cooked
4 Air-guiding plate
5 Transmitter/receiver unit
6 High-frequency signal
7 Coupling device
8 Planar antenna
9 Sensor
10 Electrical line
11 Shield
12 Heating coil
13 Steam generator
14 Microwave generator
15 Fan
16 Side wall
17 Mounting
18 Opening
19 Air openings
801 Method step
802 Method step
t Time axis
t1 Time
t2 Time
Δt Time period
S Signal axis

1-15. (canceled)

16. A cooking appliance, comprising:
a cooking chamber for cooking a product to be cooked;
an air-guiding plate arranged in the cooking chamber;
a transmitter/receiver unit configured to transmit and/or receive a high-frequency signal;
a coupling device configured to couple the transmitter/receiver unit and the air-guiding plate; and
a sensor configured for arrangement in the cooking chamber,
said air-guiding plate being configured in the form of a planar antenna for transmitting the high-frequency signal between the coupling device and the sensor.

17. The cooking appliance of claim 16, wherein the coupling device comprises a spiral-shaped electrical line for capacitive coupling with the air-guiding plate for transmitting the high-frequency signal.

18. The cooking appliance of claim 17, wherein the spiral-shaped electrical line is arranged to a rear, to a front, above, below or to a side relative to the air-guiding plate.

19. The cooking appliance of claim 17, further comprising a mounting configured to fix the air-guiding plate to at least one side wall of the cooking chamber, said spiral-shaped electrical line being arranged relative to the air-guiding plate at a position which is dependent on the position of the mounting.

20. The cooking appliance of claim 17, wherein the spiral-shaped electrical line is arranged relative to the air-guiding plate at a position which is dependent on a spacing of an edge of the air-guiding plate from a side wall of the cooking chamber, such that an impedance of the air-guiding plate is adapted to an impedance of the coupling device.

21. The cooking appliance of claim 17, wherein the spiral-shaped electrical line is configured as a component which is removable or capable of being added.

22. The cooking appliance of claim 20, wherein the air-guiding plate has an opening for passage of the component.

23. The cooking appliance of claim 17, wherein the spiral-shaped electrical line is produced from a heat-resistant spring material.

24. The cooking appliance of claim 16, wherein the air-guiding plate is produced from a steel plate which is coated with an electrically insulating layer.

25. The cooking appliance of claim 16, wherein the air-guiding plate is enameled.

26. The cooking appliance of claim 16, further comprising an earth line configured to galvanically couple an earth for the planar antenna to a side wall of the cooking chamber.

27. The cooking appliance of claim 16, wherein the planar antenna is configured to transmit the high-frequency signal in an ISM band.

28. The cooking appliance of claim 16, wherein the transmitter/receiver unit is configured in at least one of three ways, a first way in which the transmitter/receiver unit transmits a first high-frequency signal via the planar antenna to the sensor, a second way in which the transmitter/receiver unit receives a second high-frequency signal provided by the sensor via the planar antenna at a predeterminable time, a third way in which the transmitter/receiver unit receives the second high-frequency signal provided by the sensor via the planar antenna in response to a presence of a triggering signal.

29. The cooking appliance of claim 16, further comprising at least one member selected from the group consisting of a heating coil, a steam generator, a microwave generator and a fan.

30. The cooking appliance of claim 16, being constructed as at least one member selected from the group consisting of an oven, a microwave oven and a steam cooker.

31. A method for operating a cooking appliance which includes a cooking chamber and a coupling device for coupling a transmitter/receiver unit and an air-guiding plate which is arranged in the cooking chamber, said method comprising transmitting between the transmitter/receiver unit and a sensor arranged in the cooking chamber, a high-frequency signal via a planar antenna which forms the air-guiding plate.
